(19) United States
(12) Patent Application Publication
(10) Pub. No.: US 2015/0102933 A1
(43) Pub. Date: Apr. 16, 2015

(54) SERVICE DISPLAY SYSTEM FOR A MACHINE

(71) Applicant: Caterpillar Global Mining HMS GmbH, Dortmund (DE)

(72) Inventor: Sebastian Capraro, Dortmund (DE)

(73) Assignee: Caterpillar Global Mining HMS GmbH, Dortmund (DE)

(21) Appl. No.: 14/572,802

(22) Filed: Dec. 17, 2014

(51) Int. Cl. G01F 23/00; G08B 5/36

(52) U.S. Cl. CPC G01F 23/0007; G08B 5/36
USPC 340/618

(57) ABSTRACT

A service display system for a machine with an out-board service area is disclosed. The service display system indicates a plurality of fluid levels within a plurality of fluid reservoirs, corresponding to respective one of a plurality of sub-systems. The service display system includes a port relay board disposed within the out-board service area. The port relay board includes a plurality of fluid fill ports that correspond to one of the plurality of fluid reservoirs. The port relay board includes a first indicator and at least one second indicator disposed within proximity of the plurality of fluid fill ports. The first indicator is adapted to communicate at least one fluid level of the at least one of the plurality of fluid reservoirs. The at least one second indicator is adapted to visibly indicate an inclination position of the machine.

### TECHNICAL FIELD

The present disclosure relates to hydraulic machines. More particularly, the present disclosure relates to a service display system for a machine.

### BACKGROUND

Mining, construction, and other large-scale excavation operations, generally require fleet of digging, loading, and/or hauling machines to remove and transport excavated material, such as ore or other loads. Material may be transported from one area of excavation to multiple different destinations at a common worksite. For such operations to be profitable, the fleet of machines must be productively and efficiently operated. Hence, for service and maintenance purposes, the machine may record and transmit machine data to a central operator station while in operation. The machine data may include payload, engine speed, machine inclination, fluid characteristics (such as levels, contamination, viscosity, temperature, pressure, and so on), fuel consumption, exhaust emissions, braking conditions, transmission characteristics, and/or the like.

Due to the mobile nature of the machine, the machine data is required to determine the supply of the plurality of fluids, such as diesel fuel, engine coolant, pump transmission gear oil, engine oil, hydraulic oil, grease, and/or the like. Conventionally, the machine data may be shown in a display connected to the central operator station. An operator that fills the said plurality of fluids of machine may be required to download the machine data, from the central operator station, and thereafter may initiate the filling operations. Service stations, which are used to provide a single access panel to fill the machine with fuel, hydraulic fluid, oil, grease and other necessary fluids, may be provided to the machines. During the fill up of the fluids, the machine has to be in a horizontal position. That is, the machine should not be inclined at a ramp, hill, and/or the like. This implies that it is best to fill the machine when the machine is on a level surface. This allows for a true reading of how much fluid capacity remains in the respective fluid reservoirs. In harsh conditions, it may be unfavorable for the operator to download the machine data from the central operator station. This makes the filling operation inefficient and less productive.

### SUMMARY OF THE INVENTION

The present disclosure relates to a service display system for a machine with an out-board service area.

In accordance with the present disclosure, the service display system indicates a plurality of fluid levels within a plurality of fluid reservoirs, coupled to respective one of a plurality of sub-systems. The service display system includes a port relay board disposed within the out-board service area. The port relay board includes a plurality of fluid fill ports that correspond to the plurality of fluid reservoirs. The port relay board includes a first indicator and at least one second indicator, which are disposed within proximity to the plurality of fluid fill ports. The first indicator is adapted to communicate at least one fluid level of the at least one of the plurality of fluid reservoirs. The at least one second indicator is adapted to communicate machine inclination and visibly and to indicate an inclination position of the machine.

### BRIEF DESCRIPTION OF THE DRAWINGS

FIG. 1 is a perspective view of a machine, such as a mining shovel, in accordance with the concepts of the present disclosure;

FIG. 2 is a perspective view of a rear portion of the machine of FIG. 1, in accordance with the concepts of the present disclosure;

FIG. 3 illustrates a schematic of a service display system of the machine of FIG. 2, in accordance with the concepts of the present disclosure; and

FIG. 4 illustrates a flow chart for a method to display inclination position and a fluid level in the machine of FIG. 2, in accordance with the concepts of the present disclosure.

### DETAILED DESCRIPTION

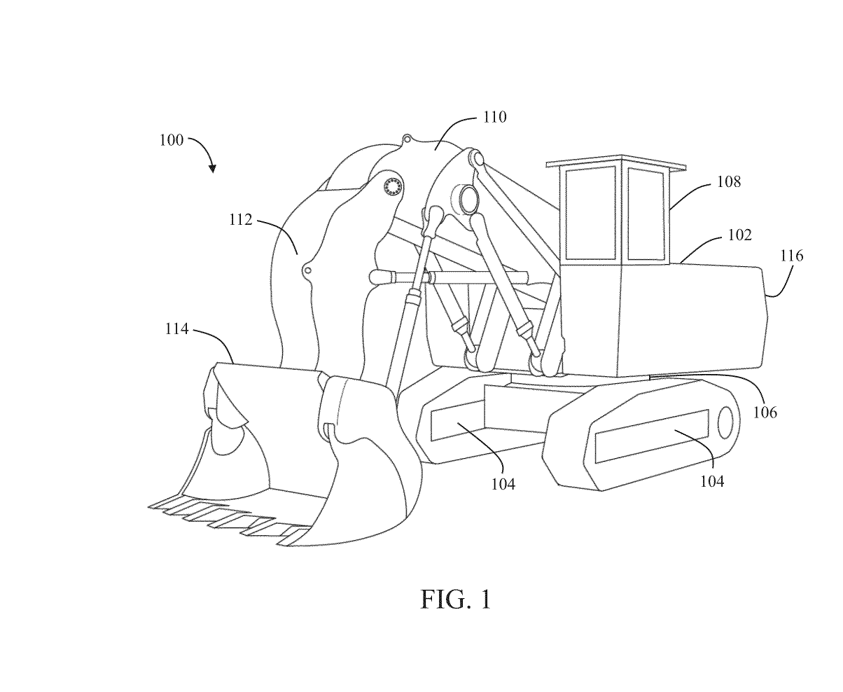

Referring to FIG. 1, there is shown a machine 100. The machine 100 may be a wheeled or tracked industrial vehicle. Examples of the machine 100 may be, but are not limited to, a mining shovel, excavator, material loader, dozer, and/or the like. In the described embodiment, the machine 100 embodies a tracked mining shovel, which may be used to load or unload material in mining and construction areas. The machine 100 includes a frame 102, one or more traction devices 104, a base 106, a power source 108, a boom 110, a stick 112, an implement 114, and a cab 116.

The frame 102 includes any structural member or assembly of members that supports movement of the machine 100. The frame 102 is supported on the one or more traction devices 104. The frame 102 supports the stationary base 106 that connects the one or more traction devices 104 (such as wheels, tracks, and/or the like) to the power source 108. The traction devices 104 are powered and driven by the power source 108. The power source 108 generates rotational power to feed the traction devices 104 to propel the machine 100 in a desired direction for operation. The power source 108 may be an engine, such as a diesel engine, a gasoline engine, a gaseous fuel-powered engine, a natural gas engine, or other engine known to one skilled in the art. The power source 108 is supported by the frame 102, and configured to produce mechanical and/or electrical power output used to drive operation of a steering component (not shown) and the implement 114.

The boom 110 is coupled to the body of the machine 100. The boom 110 is actuated by one or more boom cylinders 118. The boom cylinders 118 are coupled to the frame 102 at one end and to the boom 110 at a second end. The boom 110 is pivotally coupled to the stick 112. The stick 112 is actuated by one or more stick cylinders 120. The one or more stick cylinders 120 are configured to tilt the stick 112 with respect to the boom 110. The stick 112, in turn, is pivotally coupled to the implement 114. The implement 114 may embody a specialized device, such as a bucket, a shovel, or the like. The special device is used in the performance of a particular task. The implement 114 is connected to the frame 102, via the stick 112, and moves relative to the frame 102. The implement 114 is lifted by the one or more boom cylinders 118 and tilted by the stick cylinders 120. In an exemplary embodiment, the implement 114 defines a bowl-shaped portion that holds material. The implement 114 includes a rear wall portion, which is pivotally coupled to the stick 112. It is also contemplated that the implement 114 may alternatively or additionally be configured to pivot, rotate, slide, swing, or move in other ways relative to the frame 102, via a pair of implement cylinders 122.

The implement 114 is operated from the cab 116. The cab 116 is supported on the frame 102 and includes one or more operator interface devices (not shown), such as a steering wheel, single or multi-axis joysticks, switches, knobs, or other known devices that are located proximal to an operator seat. Further, the cab 116 houses a primary display station, which may be configured to show fluid levels of one or more fluid reservoirs. The one or more fluid reservoirs are associated with a plurality of sub-systems, such as lubrication system, fuel system, cooling system, and/or the like.

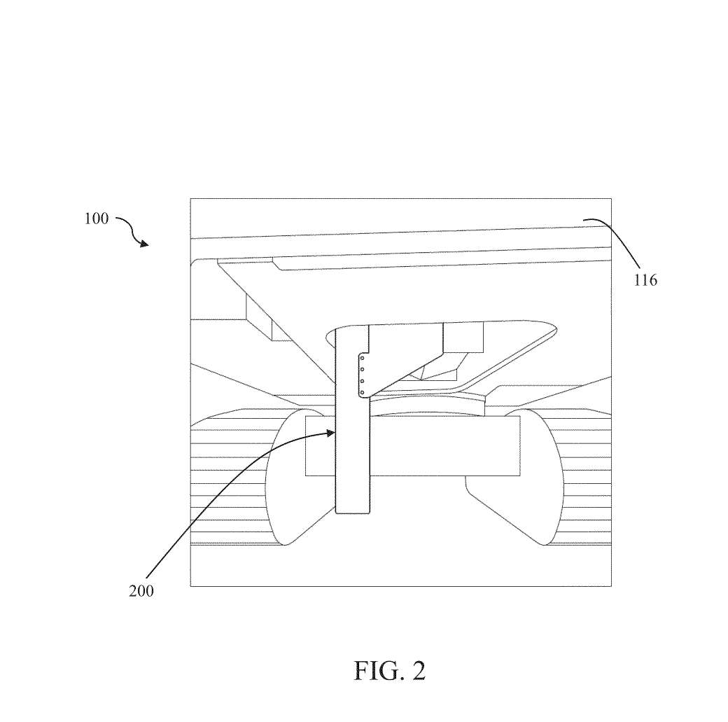

Referring to FIG. 2, there is shown a rear portion 200 of the machine 100. The rear portion 200 of the machine 100 is shown with a port relay board 202 installed underneath the power source 108 (as shown in FIG. 1). The port relay board 202 is retractable and easily accessible from the ground. In the retracted position, the port relay board 202 is aligned with the frame 102. In the described embodiment, the port relay board 202 is shown in a serviceable position, thereby allowing an operator to execute the filling operation.

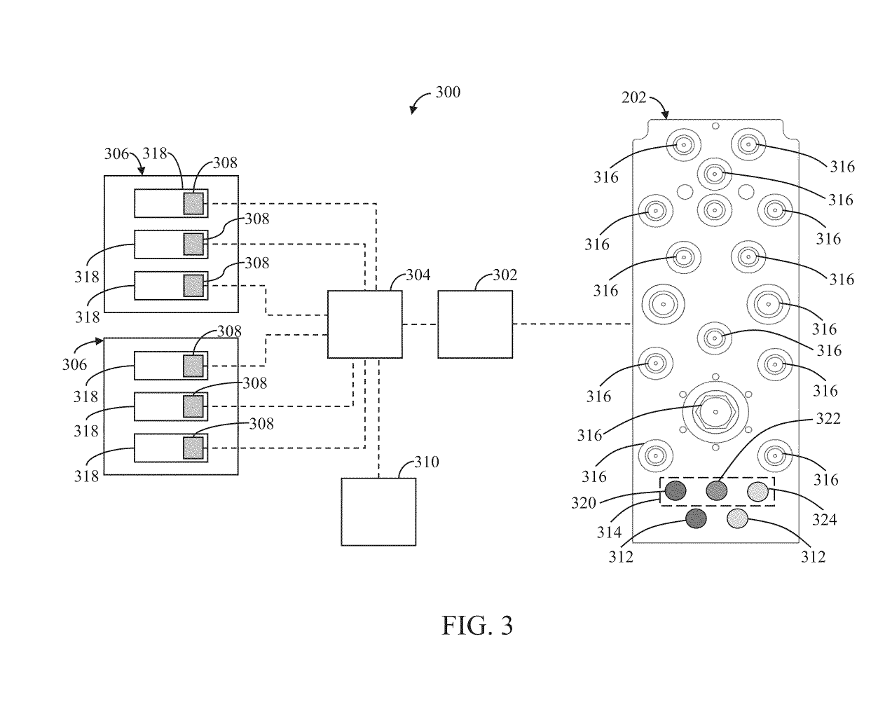

Referring to FIG. 3, there is shown a schematic of a service display system 300. The service display system 300 includes the port relay board 202, a cab display station 302, a processor 304, the plurality of sub-systems 306, a plurality of fluid level sensors 308, and at least one inclination sensor 310. The cab display station 302 is connected to the processor 304. The processor 304 is adapted to facilitate communication between various sensors installed on the machine 100 and the cab display station 302. The cab display station 302 is in control communication with the port relay board 202, via a controller area network (CAN) bus network. The port relay board 202 may include at least one first indicator 312, at least one second indicator 314 and a plurality of fluid fill ports 316. The plurality of fluid fill ports 316 may include at least one coolant port, at least one lubricant port, at least one relief valve port, at least one pump drive port, at least one hydraulic oil port, at least one oil extension port, at least one fuel port, and at least one engine oil port. Each of the plurality of fluid fill ports 316 are connected to the respective sub-systems 306, so as to deliver respective fluid to the sub-systems 306. Each of the plurality of sub-systems 306 include at least one respective fluid reservoir 318, to retain the fluid filled via the respective fluid fill ports 316. The fluid reservoirs 318 are equipped with the one or more fluid level sensors 308, adapted to measure fluid levels in the fluid reservoirs 318 of the sub-systems 306. The fluid level sensors 308 are in control communication with the processor 304. The processor 304 is adapted to receive fluid level information from the fluid level sensors 308 and deliver the information to the cab display station 302. The cab display station 302 displays the fluid level information received by the processor 304. Further, the fluid level information is delivered from the cab display station 302 to the port relay board 202, via the CAN bus connection, and displayed via the first indicator 312. However, in an embodiment the processor 304 may be in control communication with the port relay board 202 and the cab display station 302.

The first indicator 312 is positioned in proximity to the plurality of fluid fill ports 316. The first indicator 312 is in control communication with the fluid level sensors 308, via the cab display station 302. The first indicator 312 is configured to visually represent fluid levels of the respective fluid reservoirs 318 of the sub-systems 306. In an embodiment, the first indicator 312 may include a plurality of lights, such that each light corresponds to a pre-determined fluid level range.

Further, the service display system 300 is equipped with the at least one inclination sensor 310, which is in control communication with the processor 304. The inclination sensor 310 is configured to measure an inclination position of the machine 100. The inclination sensor 310 also determines deviation from a horizontal machine position based on the inclination position of the machine 100, and transmits inclination position information to the processor 304. The processor 304 communicates the inclination position information to the cab display station 302, which in turn, communicates the inclination position information to the port relay board 202. At the port relay board 202, the inclination position information is displayed via the second indicator 314. In an embodiment of the present disclosure, the processor 304 corrects the value of fluid levels displayed in cab display station 302 and first indicator 312 based on the inclination measured by inclination sensor 310, using customary methodology such as applying trigonometric equations to determine the unknown levels.

The second indicator 314 is positioned in proximity to the plurality of fluid fill ports 316. The second indicator 314 is in control communication with the inclination sensor 310, via the cab display station 302. The second indicator 314 is configured to visually represent machine inclination. In an embodiment, the second indicator 314 may include a plurality of lights, such that each light corresponds to a pre-determined machine inclination range. For example, the second indicator 314 includes a first light 320, a second light 322, and a third light 324. The first light 320 includes a first color and is indicative of a first pre-determined inclination range from the horizontal machine position. The second light 322 has a second color and is indicative of a second pre-determined inclination range from the horizontal machine position. The third light 324 has a third color and is indicative of a third pre-determined inclination range from the horizontal machine position. In an exemplary embodiment of the disclosure, the first pre-determined range is 0 degrees-5 degrees, the second pre-determined range is between 5 degrees-10 degrees and the third pre-determined range is between 10 degrees-20 degrees, for example. Alternatively, other ranges may be programmed based on user preference.

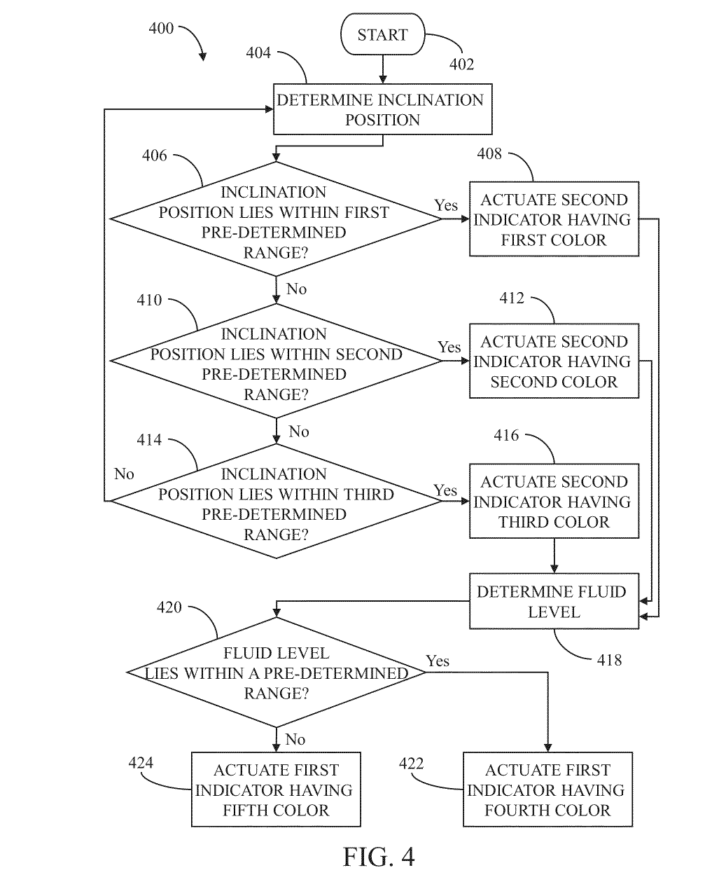

Referring to FIG. 4, there is shown a flow chart that depicts a method 400 to display the inclination position and the fluid level. The method 400 starts with step 402 and proceeds to step 404.

At step 404, the processor 304 determines the inclination of the machine 100 by use of the inclination sensor 310. The method 400 proceeds to step 406.

At step 406, the processor 304 determines whether inclination position is within the first pre-determined inclination range. If the determined inclination position is within the first pre-determined inclination range, then the method 400 proceeds to step 408. If the determined inclination position is not within the first pre-determined inclination range, then the method 400 proceeds to step 410.

At step 408, the processor 304 signals the cab display station 302 for visual display of the inclination position. Thereafter the signal is communicated to the port relay board 202 for actuation of the first light 320 that corresponds to the first color. The method 400 proceeds to step 418.

At step 410, the processor 304 determines whether the determined inclination position is within the second pre-determined inclination range. If the determined inclination position is within the second pre-determined inclination range, then the method 400 proceeds to step 412. If the determined inclination position is not within the second pre-determined inclination range, then the method 400 proceeds to step 414.

At step 412, the processor 304 signals the cab display station 302 for visual display of the inclination position. Thereafter the signal is communicated to the port relay board 202 for actuation of the second light 322 that corresponds to the second color. The method 400 proceeds to step 418.

At step 414, the processor 304 determines whether the determined inclination position is within the third pre-determined inclination range. If the determined inclination position is within the third pre-determined inclination range, then the method 400 proceeds to step 416. If the determined inclination position is not within the third pre-determined inclination range, then the method 400 proceeds to step 404.

At step 416, the processor 304 signals the cab display station 302 for visual display of the inclination position. Thereafter the signal is communicated to the port relay board 202 for actuation of the third light 324 that corresponds the third color. The method 400 proceeds to step 418.

At step 418, the controller determines the fluid levels in the plurality of fluid reservoirs 318, based on the fluid level information received form the plurality of fluid level sensors 308. The method 400 proceeds to step 420.

At step 420, the processor 304 determines whether the fluid level is within the pre-determined fluid level range. If the determined fluid level is within the pre-determined fluid level range, then the method 400 proceeds to step 422. If the determined inclination position is not within the pre-determined fluid level range, then the method 400 proceeds to step 424.

At step 422, the processor 304 signals the cab display station 302 for visual display of the fluid level. Thereafter the signal is communicated to the port relay board 202 for actuation of the first indicator 312 that corresponds to a fourth color.

At step 424, the processor 304 signals the cab display station 302 for visual display of the fluid level. Thereafter the signal is communicated to the port relay board 202 for actuation of the first indicator 312 that corresponds to a fifth color. It is contemplated that an alarm may also be activated to notify the operator regarding the fluid levels in the system.

### INDUSTRIAL APPLICABILITY

In operation, the operator may want to know the machine inclination and the fluid level information in order to provide an efficient filling operation. For this purpose, the inclination sensor 310 determines the inclination position of the machine 100 and generates the machine inclination information. Further, the fluid level sensors 308 measure the fluid level in the fluid reservoir 318 and generate the fluid level information. The processor 304, in control communication with the fluid level sensors 308 and the inclination sensor 310, signals the cab display station 302 for visual display, based on the determined fluid level and the determined machine inclination. The cab display station 302, which is in control communication with the port relay board 202, communicates the fluid level information and the machine inclination information to the port relay board 202. Hence, at the port relay board 202, at least one of the first indicators 312, and the second indicator 314, are actuated based on the determined fluid level and the determined machine inclination.

When the operator performs the filling operation for a particular fluid reservoir 318, the first indicator 312 provides the fluid level information to the operator. The second indicator 314 provides the machine inclination information to the operator. This allows the operator to have information related to the fluid level and the machine inclination. Further, this allows the operator to determine whether the machine 100 is in an optimum position for filing operation. This also helps the operator to estimate the amount of fluid to be filled during the filling operation. In the current port relay boards, lack of the first indicator 312 and the second indicator 314, may cause inconvenience to the operator when filling operation is to be performed. Hence, the disclosed port relay board 202 facilitates an efficient filling operation and increased operator reliability.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A service display system for a machine having an out-board service area for indicating a plurality of fluid levels within a plurality of fluid reservoirs respective of a plurality of sub-systems, the service display system comprising:
a port relay board disposed within the out-board service area, the port relay board including a plurality of fluid fill ports, each of the plurality of fluid fill ports connected to a respective one of the plurality of fluid reservoirs, the port relay board including:
a first indicator disposed within proximity to the plurality of fluid fill ports within the out-board service area, the first indicator being adapted to communicate at least one fluid level of the at least one of the plurality of fluid reservoirs; and
at least one second indicator disposed within proximity to the plurality of fluid fill ports within the out-board service area, the at least one second indicator being adapted to communicate machine inclination and visibly indicate an inclination position of the machine.

2. The service display system of the machine of claim 1, is in communication with a cab display station.

3. The first indicator of claim 1, includes plurality of lights such that each light corresponds to a pre-determined fluid level range.

4. The service display system of claim 1, includes a processor to compensate the fluid level in the respective fluid reservoirs of the plurality of sub-systems based on the inclination position of the machine.
